(19) United States
(12) Patent Application Publication
(10) Pub. No.: US 2004/0000855 A1
(43) Pub. Date: Jan. 1, 2004

(54) Insulator system for a CRT focus mask

(76) Inventors: Samuel Paul Benigni, Lititz, PA (US); Donald Walter Bartch, York, PA (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/183,177

(22) Filed: Jun. 26, 2002

(51) Int. Cl. H01J 29/81; H01J 29/07

(52) U.S. Cl. 313/402

(57) ABSTRACT

The present invention relates to a color cathode-ray tube having an evacuated envelope with an electron gun therein for generating at least one electron beam. The envelope further includes a faceplate panel having a luminescent screen with phosphor lines on an interior surface thereof. A tensioned focus mask, having a plurality of spaced-apart first conductive lines, is located adjacent to an effective picture area of the screen. The spacing between the first conductive lines defines a plurality of slots substantially parallel to the phosphor lines on the screen. Each of the first conductive lines has a substantially continuous insulating material layer formed on a screen-facing side thereof. A plurality of second conductive lines are oriented substantially perpendicular to the plurality of first conductive lines and are bonded thereto by an insulator. The insulator is typically comprised of one or more electrically insulating material layers, a base coat and a top coat. The electrically insulating material layers comprising either of the base or top coat may be a composite material comprising at least one of a nitride-containing compound, a silicon-containing compound, a boron-containing compound and a metal oxide-containing compound. Optionally, a lead based glass insulator may be used with the composite insulating material.

### BACKGROUND OF THE INVENTION

1. Field of the Invention

This invention relates to a color cathode-ray tube (CRT) and, more particularly to a color CRT having a tensioned focus mask.

2. Description of the Background Art

A color cathode-ray tube (CRT) typically includes at least one electron gun, an aperture mask, and a screen. The aperture mask is interposed between the electron gun and the screen. The screen is located on an inner surface of a faceplate of the CRT. The screen has an array of three different color emitting phosphors (e. g., green, blue, red) formed thereon. The aperture mask functions to direct electron beams generated in the electron guns toward appropriate color emitting phosphors on the screen of the CRT.

The aperture mask may be a focus mask. Focus masks typically comprise two sets of conductive lines (or wires) that are arranged orthogonal to each other, to form an array of openings. Different voltages are applied to the two sets of conductive lines so as to create a multipole focusing lens in each opening of the mask. The multipole focusing lenses are used to direct and focus the electron beams onto the appropriate color emitting phosphors on the screen of the CRT tube.

One type of focus mask is a tensioned focus mask, wherein at least one of the sets of conductive lines is under tension. Typically, for tensioned focus masks, the vertical set of conductive lines is under tension, with the horizontal set of conductive lines overlying such vertical tensioned lines. An electrical insulating material separates the vertical conductive lines from the horizontal conductive lines.

The electrical insulating material may be composed of two or more layers. Prior art CRT focus mask insulating materials typically incorporated two lead-based glass layers which require separate thermal cycles to melt, flow and cure the two material layers. Such thermal cycles are time consuming, necessitating time periods for each cycle of up to about 10 hours to cure the insulating material layers. Additionally, lead containing materials require special handling and disposal procedures due to their environmental toxicity.

Thus, a need exists for suitable insulating materials that overcome or minimize the above-mentioned drawbacks of lead-based glass insulators for CRT focus masks.

### SUMMARY OF THE INVENTION

The present invention relates to a color cathode-ray tube (CRT) having an evacuated envelope with an electron gun therein for generating at least one electron beam. The envelope further includes a faceplate panel having a luminescent screen with phosphor lines on an interior surface thereof. A tensioned focus mask, having a plurality of spaced-apart first conductive lines, is located adjacent to an effective picture area of the screen. The spacing between the first conductive lines defines a plurality of slots substantially parallel to the phosphor lines on the screen. Each of the first conductive lines has a substantially continuous electrically insulating material layer formed on a screen-facing side thereof. A plurality of second conductive lines are oriented substantially perpendicular to the plurality of first electrically conductive lines and are bonded thereto by an electrical insulator. The electrical insulator is typically comprised of one or more insulating material layers, a base coat and a top coat. The insulating material layers comprising either of the base or top coat may be a composite material comprising at least one of a nitride-containing compound, a silicon-containing compound, a boron-containing compound and a metal oxide-containing compound. Optionally, a lead-based glass insulator may be used with the composite insulating material.

### BRIEF DESCRIPTION OF THE DRAWING

The invention will now be described in greater detail, with relation to the accompanying drawings, in which:

FIG. 1 is a plan view, partly in axial section, of a color cathode-ray tube (CRT) including a uniaxial tension focus mask-frame assembly embodying the present invention;

FIG. 2 is a plan view of the uniaxial tension focus mask-frame assembly of FIG. 1;

FIG. 3 is a front view of the mask-frame assembly taken along line 3-3 of FIG. 2;

FIG. 4 is an enlarged section of the uniaxial tension focus mask shown within the circle 4 of FIG. 2;

FIG. 5 is a view of the uniaxial tension focus mask and the luminescent screen taken along lines 5-5 of FIG. 4; and

FIG. 6 is an enlarged view of a portion of the uniaxial tension focus mask within the circle 6 of FIG. 5.

### DETAILED DESCRIPTION OF THE PREFERRED EMBODIMENT

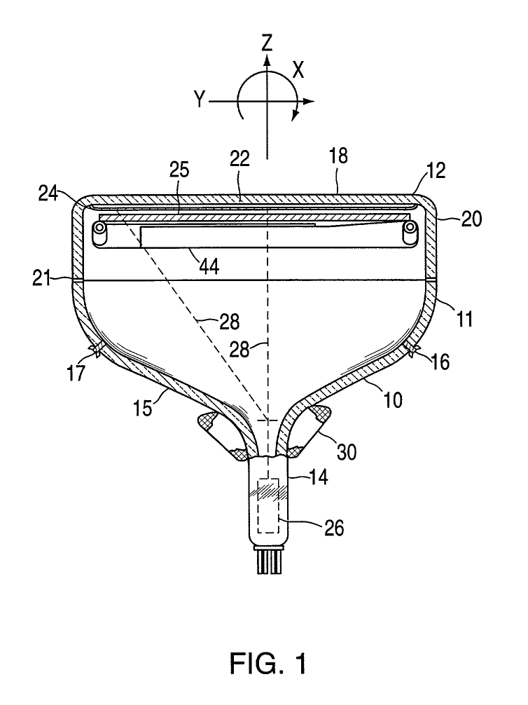

FIG. 1 shows a color cathode-ray tube (CRT) 10 having a glass envelope 11 comprising a rectangular faceplate panel 12 and a tubular neck 14 connected by a rectangular funnel 15. The funnel has an internal conductive coating (not shown) that is in contact with, and extends from, a first anode button 16 to the neck 14. A second anode button 17, located opposite the first anode button 16, is not contacted by the conductive coating.

The panel 12 comprises a cylindrical viewing faceplate 18 and a peripheral flange or sidewall 20 that is sealed to the funnel 15 by a glass frit 21. A three-color luminescent phosphor screen 22 is carried on the inner surface of the faceplate 18. The screen 22 is a line screen, shown in detail in FIG. 5, that includes a multiplicity of screen elements comprised of red-emitting, green-emitting, and blue-emitting phosphor lines, R, G, and B, respectively, arranged in triads, each triad including a phosphor line of each of the three colors. Preferably, a light absorbing matrix 23 separates the phosphor lines. A thin conductive layer 24, preferably of aluminum, overlies the screen 22 and provides means for applying a uniform first anode potential to the screen as well as for reflecting light, emitted from the phosphor elements, through the faceplate 18.

A cylindrical multi-aperture color selection electrode, or uniaxial tension focus mask 25, is removably mounted, by conventional means, within the panel 12, in predetermined spaced relation to the screen 22. An electron gun 26, shown schematically by the dashed lines in FIG. 1, is centrally mounted within the neck 14 to generate and direct three inline electron beams 28, a center and two side or outer beams, along convergent paths through the mask 25 to the screen 22. The inline direction of the beams 28 is normal to the plane of the paper.

The CRT of FIG. 1 is designed to be used with an external magnetic deflection yoke, such as the yoke 30, shown in the neighborhood of the funnel-to-neck junction. When activated, the yoke 30 subjects the three electron beams to magnetic fields that cause the beams to scan a horizontal and vertical rectangular raster over the screen 22. The uniaxial tension mask 25 is formed, preferably, from a thin rectangular sheet of about 0.05 mm (2 mil) thick low carbon steel (about 0.005% carbon by weight). Suitable materials for the uniaxial tension mask 25 may include high expansion, low carbon steels having a coefficient of thermal expansion (COE) within a range of about 120-160×10⁻⁷/< C.; intermediate expansion alloys such as, iron-colbalt-nickel (e. g., KOVAR™) having a coefficient of thermal expansion within a range of about 40-60×10⁻⁷/< C.; as well as low expansion alloys such as iron-nickel (e. g., INVAR™) having a coefficient of thermal expansion within a range of about 15-30×10⁻⁷/< C.

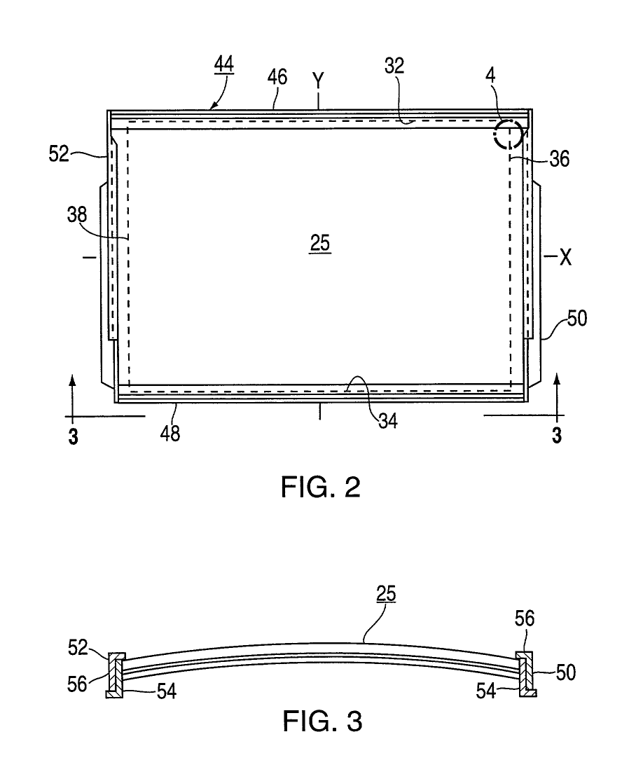

As shown in FIG. 2, the uniaxial tension mask 25 includes two long sides 32, 34 and two short sides 36, 38. The two long sides 32, 34 of the tension mask 25 are parallel with the central major axis, X, of the CRT while the two short sides 36, 38 are parallel with the central minor axis, Y, of the CRT.

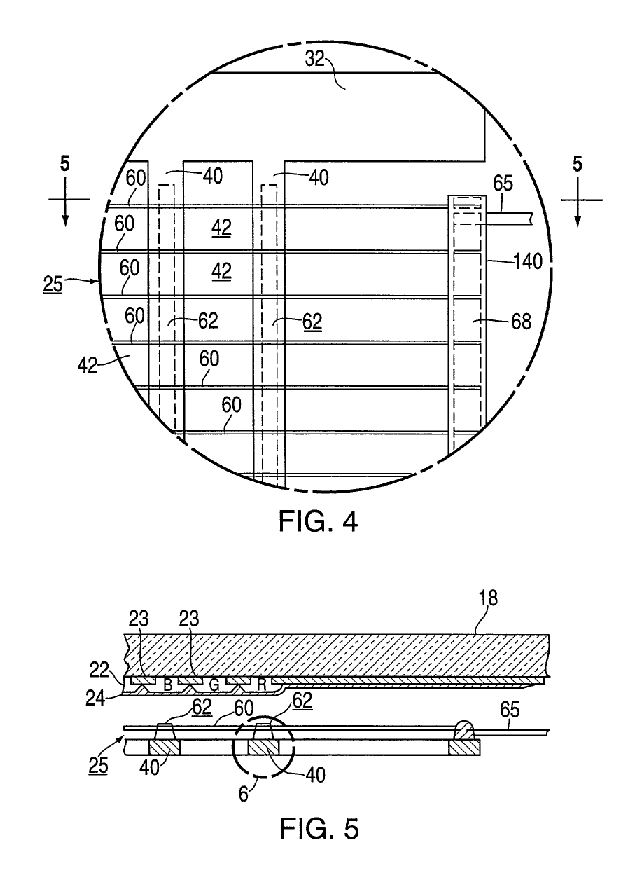

The tension mask 25 includes an aperture portion that is adjacent to and overlies an effective picture area of the screen 22, which lies within the central dashed lines of FIG. 2 that define the perimeter of the mask 25. As shown in FIG. 4, for a diagonal dimension of 68 cm (27 V) the uniaxial tension focus mask 25 includes a plurality of first metal strands 40 (conductive lines), each having a transverse dimension, or width, of about 0.3 mm (12 mils) separated by substantially equally spaced slots 42, each having a width of about 0.55 mm (21.5 mils) that parallel the minor axis, Y, of the CRT and the phosphor lines of the screen 22. In a color CRT having a diagonal dimension of 68 cm (27 V), there are about 600 of the first metal strands 40. Each of the slots 42 extends from one long side 32 of the mask to the other long side 34 thereof (not shown in FIG. 4).

A frame 44, for the tensioned mask 25, is shown in FIGS. 1-3, and includes four major members, two torsion tubes or curved members 46, 48 and two tension arms or straight members 50, 52. The two curved members 46, 48 are parallel to the major axis, X, and each other. As shown in FIG. 3, each of the straight members 50, 52 includes two overlapped partial members or parts 54, 56, each part having an L-shaped cross-section. The overlapped parts 54, 56 are welded together where they are overlapped. An end of each of the parts 54, 56 is attached to an end of one of the curved members 46, 48. The curvature of the curved members 46, 48 matches the cylindrical curvature of the uniaxial tension focus mask 25. The long sides 32, 34 of the uniaxial tension focus mask 25 are welded between the two curved members 46, 48, which provides the necessary tension to the mask. Before welding the long sides 32, 34 of the mask to the frame 44, the mask material is pre-stressed and darkened by tensioning the mask material while heating it, in a controlled atmosphere of nitrogen and oxygen, at a temperature of about 500< C., for about one hour. The frame 44 and the mask material, when welded together, comprise a uniaxial tension mask assembly.

With reference to FIGS. 4 and 5, a plurality of second metal strands (conductive lines) 60, each having a diameter of about 0.025 mm (1 mil), are disposed substantially perpendicular to the first metal strands 40 and are spaced therefrom by an insulator 62 formed on the screen-facing side of each of the first metal strands 40. The second metal strands 60 form cross members that facilitate the application of a second anode, or focusing, potential to the mask 25. Suitable materials for the second metal strands include iron-nickel steel such as Invar and/or carbon steels such as HyMu80 wire (commercially available from Carpenter Technology, Reading, Pa.).

The vertical spacing, or pitch, between adjacent second metal strands 60 is about 0.33 mm (13 mils) for a diagonal dimension of 68 cm (27 V). The relatively thin second metal strands 60 provide the essential focusing function of the uniaxial tension focus mask 25 without adversely affecting the electron beam transmission thereof. The uniaxial tension focus mask 24, described herein, provides a mask transmission, at the center of the screen, of about 40-45%, and requires that the second anode, or focusing, voltage, ΔV, applied to the second metal strands 60, differs from the first anode voltage applied to the first metal strands 40 by less than about 1 kV, for a first anode voltage of about 30 kV.

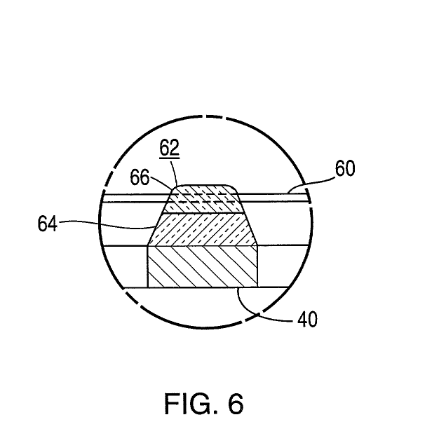

The insulators 62, shown in FIGS. 4-6, are disposed substantially continuously on the screen-facing side of each of the first metal strands 40. The second metal strands 60 are bonded to the insulators 62 to electrically isolate the second metal strands 60 from the first metal strands 60.

The insulators 62 are formed of a suitable material that has a thermal expansion coefficient that is matched to the material of the uniaxial tension focus mask 25. The material of the insulators should have a relatively low melting temperature so that it may flow, cure, and adhere to both the first and second metal strands 40, 60 within a temperature range of less than about 450< C. The insulator material should also have a dielectric breakdown strength in excess of about 4000 V/mm (100 V/mil), with bulk and surface electrical resistivities in excess of about 10¹³ ohm-cm and 10¹³ ohm/square, respectively. Additionally, the insulator material should be stable at temperatures used for sealing the CRT faceplate panel 12 to the funnel (typically about 450< C. to about 500< C.), as well as have adequate mechanical strength and elastic modulus, and be low outgassing during processing and operation for an extended period of time within the radiative environment of the CRT.

The insulators 62 are composed of one or more insulating material layers: a base coat 64 and a top coat 66. Each insulating material layer may be a composite of at least one of a nitride-containing compound, a silicon-containing compound, a boron-containing compound and a metal oxide-containing compound.

Suitable composites may include aluminum nitride, boron nitride, silicon nitride, titanium diboride, titanium disilicide, zirconium nitride, chromium trioxide and silicon dioxide, among others, with boron nitride being preferred. The silicon-containing compounds may also include alkali silicates (e.g., potassium silicate, sodium silicate and lithium silicate) and organosilicates (e.g., tetraethylorthosilicate (TEOS) and tetramethylorthosilicate (TMOS)). Organosilicates are preferred and TEOS is most preferred.

The at least one of the nitride-containing compound, the silicon-containing compound, the boron-containing compound and the metal oxide-containing compound are mixed with a suitable solvent, such as for example amyl acetate and/or water or 1-propanol, with organic solvents being preferred and amyl acetate being most preferred. The ratio of the composite compound to the solvent should be in the range of 1 to 2, with a ratio of 1:1 being most preferred.

The following examples illustrate some of the methods in which the insulator material can be used in a CRT focus mask. It is understood by those in the art that these examples can be easily modified to include other embodiments of the insulator material in CRT focus masks without departing from the scope of the present invention.

### EXAMPLE 1

A nitride/silicon-based insulator mixture is used as either the base coat (first layer) or, optionally, a top coat (second layer), or both, having a composition of boron nitride of about 1-5 micron size and about 18-25% by weight (preferably about 23% by weight), potassium silicate about 36-40% by weight (preferably about 38.1% by weight) and demineralized water about 35-46% by weight (preferably about 40% by weight).

### EXAMPLE 2

A silicon-based insulator may be used as overcoat material (top coat) over a nitride/silicon-based insulator. The silicon-based insulator may have a composition of potassium silicate about 7-15% by weight (preferably about 10% by weight) and Cab-O-Sil, EH-5 Grade about 2-4% by weight (preferably about 3% by weight) and demineralized water about 81-91% by weight (preferably about 87% by weight).

### EXAMPLE 3

A nitride/silicon-based insulator having a composition of about 15-25% by weight of boron nitride (preferably about 20% by weight), TEOS about 35-45% by weight (preferably about 40% by weight) and amyl acetate about 35-45% by weight (preferably about 40% by weight).

Additionally, the following examples illustrate some of the ways in which the insulators can be used, either in conjunction with a lead based glass or without the need for a lead based glass. These examples are illustrative only and do not serve to limit the scope of the present invention.

### EXAMPLE 4

A de-vitrifying lead based glass is applied about 0.5-0.9 mm (2-3.5 mils) thick as the base coat as per procedures well known in the prior art and is cured for 10 hours at about 450 C. For example, SCC-11, a lead-zinc-borosilicate solder glass that melts in the range of 400-450 C., may be utilized as the de-vitrifying lead based glass and is commercially available from a number of glass suppliers, including Techneglass Corp, Perrysburg, Ohio. The cross wires are then wound over the base coat. A thin nitride/silicon based topcoat (as per Example 1) is then applied to a thickness of about 0.013-0.025 mm (0.5-1 mil) to bind the cross wires to the base coat. The topcoat is then baked for a maximum of 1 hour at a temperature range of 85-100 C. The resulting CRT mask shows good mechanical stability of the mask and good electrical stability in vacuum tube tests.

### EXAMPLE 5

In this Example, the application of the base coat utilizes the nitride/silicon-based insulator (as per Example 1) applied about .05-.076 mm thick and baked for a maximum of 1 hour at a temperature range of 85-100< C. The cross wires are then wound over the base coat. A thin silicon-based topcoat (as per Example 2) is then applied to a thickness of about 0.013-0.025 mm (0.5-1 mil) to bind the cross wires to the base coat. The topcoat is then baked for a maximum of 1 hour at a temperature range of 85-100 C. The resulting CRT mask shows good mechanical stability of the mask and acceptable electrical stability in vacuum tube tests.

### EXAMPLE 6

As per Example 4, a de-vitrifying lead based glass is applied about 0.5-0.9 mm (2-3.5 mils) thick as the base coat as per procedures well known in the prior art and is cured for 10 hours at about 450 C. The cross wires are then wound over the base coat. A thin nitride/silicon-based top coat (as per Example 3) is then applied to a thickness of about 0.013-0.025 mm (0.5-1 mil) to bind the cross wires to the base coat. After application, the nitride/silicon-based top coat is dried at room temperature as no topcoat bake or cure is necessary. The resulting CRT mask shows good mechanical stability of the mask and excellent electrical stability in vacuum during tube operation.

### EXAMPLE 7

As per Example 3, a nitride/silicon-based insulator is applied about 0.6-0.9 mm (2.5-3.5 mils) thick as the base coat and is cured for 1 hour at about 80 C. An overcoat of a devitrifying glass such as, SCC-11 (a lead-zinc-borosilicate glass) with about 1-3% chromium trioxide is applied about 0.3 mm (1 mil) thick. The cross wires are then wound over the overcoat and the entire unit is baked for 2 hours at 460< C. The resulting CRT mask shows good mechanical stability of the mask and excellent electrical stability in vacuum during tube operation.

As the above examples illustrate, and unlike the prior art lead frit based coats, the composite coatings comprising at least one of a nitride-containing compound, a silicon-containing compound, a boron-containing compound and a metal oxide-containing compound do not flow or melt at normal mask or tube processing temperatures (300-450< C.).

What is claimed is:

1. A cathode-ray tube comprising a tensioned focus mask, wherein the tensioned focus mask includes a plurality of spaced-apart first conductive lines having an insulating material thereon, and a plurality of spaced-apart second conductive lines oriented substantially perpendicular to the plurality of spaced-apart first conductive lines, the plurality of spaced-apart second conductive lines being bonded to the insulating material, the improvement wherein the insulating material comprises:
a composite material including at least one of a nitride-containing compound, a silicon-containing compound, a boron-containing compound and a metal oxide-containing compound.

2. The cathode-ray tube of claim 1 wherein the nitride-containing compound is selected from the group consisting of aluminum nitride, boron nitride, silicon nitride and zirconium nitride.

3. The cathode-ray tube of claim 1 wherein the boron-containing compound is selected from the group consisting of titanium diboride and boron nitride.

4. The cathode-ray tube of claim 1 wherein the silicon-containing compound is selected from the group consisting of titanium disilicide, silicon nitride and silicon dioxide.

5. The cathode-ray tube of claim 1 wherein the metal oxide-containing compound is selected from the group consisting of chromium trioxide and silicon dioxide.

6. The cathode-ray tube of claim 1 wherein the silicon-containing compound comprises one or more materials selected from the group consisting of organosilicates and alkali silicates.

7. The cathode-ray tube of claim 6 wherein the organosilicates comprise one or more materials selected from the group consisting of tetramethylorthosilicate (TMOS) and tetraethylorthosilicate (TEOS).

8. The cathode-ray tube of claim 6 wherein the alkali silicates comprise one or more materials selected from the group consisting of potassium silicate, sodium silicate and lithium silicate.

9. The cathode-ray tube of claim 1 wherein the composite material further includes a solvent.

10. The cathode-ray tube of claim 9 wherein the solvent consists of one or more materials selected from the group consisting of water, amyl acetate and propanol.

11. The cathode-ray tube of claim 1 wherein the ratio of the at least one of the nitride-containing compound, the silicon-containing compound, the boron-containing compound and the metal oxide-containing compound to the solvent is between about 1 to about 2.

12. The cathode-ray tube of claim 11 wherein the ratio of the at least one of the nitride-containing compound, the silicon-containing compound, the boron-containing compound and the oxide-containing compound to the solvent is 1:1.
